(19) United States
(12) Patent Application Publication
(10) Pub. No.: US 2011/0188859 A1
(43) Pub. Date: Aug. 4, 2011

(54) WDM-PON ARCHITECTURE BASED ON EXTERNALLY SEEDED OPTICAL SOURCE

(75) Inventors: Yang Jing Wen, Singapore (SG); Zhaowen Xu, Singapore (SG); Xiaofei Cheng, Singapore (SG); Yixin Wang, Singapore (SG)

(73) Assignee: Agency for Science, Technology and Research, Singapore (SG)

(21) Appl. No.: 12/935,419

(22) PCT Filed: Mar. 31, 2009
(86) PCT No.: PCT/SG09/00116

§ 371 Date: Apr. 21, 2011

Related U.S. Application Data
(60) Provisional application No. 61/040,819, filed on Mar. 31, 2008.

(51) Int. Cl. H04J 14/02

(52) U.S. Cl. 398/79

(57) ABSTRACT

A wavelength-division-multiplexed passive optical network (WDM PON) comprising: a remote node (RN) comprising a light source for generating a seeding signal; and one or more optical network units (ONUs), each ONU comprising a laser source configured for receiving a portion of the seeding light signal from the RN.

### FIELD OF INVENTION

The present invention relates broadly to a wavelength-division-multiplexed passive optical network (WDM PON) and to a method of externally seeding an uplink light source in an optical network unit of a WDM PON.

### BACKGROUND

In order to provide users with broadband access such as the “Triple Play” services for high-speed internet access, television, and telephone over a single broadband connection, network architectures employing fiber to the premises (FTTP) have been considered as a relatively promising technology compared with other access technologies such as xDSL (Digital Subscriber Line) and Hybrid Fiber Coaxial (HFC) networks. FTTP can be based on different types of passive optical network (PON) architectures. Among these architectures, time division multiplexed-passive optical networks (TDM-PONs) such as Ethernet PON (EPON) and Gigabit PON (GPON) have been developed extensively over the world, particularly in the western countries. However, the capacity of the TDM-PONs will eventually be pushed to their limits because of the limited capacity available per customer, due to the sharing of a single wavelength among all the customers.

As an alternative, wavelength division multiplexed-passive optical networks (WDM-PONs), in which a single wavelength carries data for a single subscriber, has been demonstrated as a favourable PON architecture, particularly for a population dense region such as Singapore, due to its relatively large capacity, high security and privacy, protocol transparency and upgrade flexibility. In this type of PON, a cost-effective light source, particularly at the optical network units (ONUs), is a key component for the practical implementation of the network.

Light sources including spectrum-sliced light-emitting diodes (LEDs), spectrum-sliced free running Fabry-Perot laser diodes (FPLDs), and a system exploiting the remodulation of downstream signals received at the ONUs have been considered for the implementation of cost-effective WDM-PONs. However, the scheme using the LEDs suffers from low power budget while the scheme comprising spectrum slicing of a free-running FPLD suffers from strong intensity noise. The re-modulation scheme needs further development to suppress crosstalk from the residual downlink data and also to alleviate the dependence of polarization state of the downlink data.

The use of centralized light sources appears to offer advantages, whereby seeding optical sources located at a central office (CO) are sent to the ONUs to improve the quality of the colorless uplink light sources such as the Fabry-Perot laser diodes (FPLDs) (H. D. Kim et. al., IEEE Photonics Technology Letters, Vol. 12, No. 8, August 2000) and the reflective semiconductor optical amplifiers (RSOAs) (Y. Katagiri et. al., Electronics Letters, Vol. 35, No. 16, 5 Aug. 1999). Seeding source using broadband light source (BLS) such as amplified spontaneous emission (ASE) noise is particularly attractive since it is polarization insensitive and stable multiple wavelength outputs can be obtained by typically slicing an ASE spectrum via the use of a multiple wavelength filter, such as an arrayed waveguide grating (AWG) or a thin film WDM demultiplexer. This scheme is also being used by companies, for example Novera Optics, where the data rate implemented is relatively low at 125 Mb/s per user.

FIG. 1 shows a scheme of upstream transmission for a WDM-PON using spectrum sliced ASE source for injection locking of FPLDs. The ASE source 100 is generated at the central office (CO) 102 and sent to the feeder fiber 106 via an optical circulator 104. The CO 102 further comprises a receiver array 108 and an AWG 110 connected to the circulator 104. The ASE source 100 is then spectrum sliced at the remote node (RN) 112 via an AWG 114 and sent to each ONU, e.g. 116, 118, via a connecting fiber, e.g. 120, 122, for injection locking of the corresponding FPLD, as proposed by H. D. Kim et. al., IEEE Photonics Technology Letters, Vol. 12, No. 8, August 2000. This scheme works relatively well for short transmission distances. However, further increase in the reach distance would be limited by the signal power budget and the backward reflection, including the backward Rayleigh scattering of the seeding light, which may be mixed with the uplink signal and consequently causing crosstalk.

FIG. 2 shows a schematic diagram illustrating an architecture 200 of a fully bi-directional, ASE spectrum sliced light source-based wavelength division multiplexed-passive optical network (WDM-PON) that utilizes the distributed Raman amplification and pump recycling techniques to address the issue of low power, as proposed by J. H. Lee et. al., ECOC 2006, Tu3.5.6, European Conference on Optical Communication, 24-28 Sep. 2006. The erbium doped fiber amplifier (EDFA) output spectrum is first spectrally sliced by an arrayed waveguide grating (AWG) and subsequently modulated with downlink data via an external modulator. The modulated signal is then combined with the Raman pump light by a 1460/1550 nm WDM coupler and transmitted over a typical single mode fiber (SMF). After the transmission, the downstream signal and the residual Raman pump power are separated by a second 1460/1550 nm WDM coupler. The downstream signal is fed to a receiver through an AWG for downlink detection while the residual Raman pump power is coupled into an erbium doped fiber (EDF) to generate an ASE spectrum. The generated ASE is then spectrally sliced through an AWG for the uplink light source. In the upstream transmission, each upstream signal is modulated with the uplink data via external modulation and wavelength multiplexed, by another AWG for upstream transmission.

However, the architecture 200 requires two AWGs at the remote node and two drop fibers for each ONU for the uplink transmission and the downlink transmission respectively, which may affect the practical implementation of the WDM-PON in terms of cost. Furthermore, direct modulation of the ASE noise limits the data rate due to excessive intensity noise.

A need therefore exists to provide a wavelength-division-multiplexed passive optical network (WDM PON) and a method of externally seeding uplink an uplink light source in WDM PON that seek to address at least one of the abovementioned problems.

### SUMMARY

According to a first aspect of the present invention there is provided a wavelength-division-multiplexed passive optical network (WDM PON) comprising a remote node (RN) comprising a light source for generating a seeding signal; and one or more optical network units (ONUs), each ONU comprising a laser source configured for receiving a portion of the seeding light signal from the RN.

The light source may comprise a circulator and an erbium doped fiber (EDF) coupled between two adjacent ports of the circulator.

One port of the circulator may be configured for receiving an optical signal comprising a pump signal for the EDF and downlink signals and for circulating the received optical signal to the EDF.

Another port of the circulator may be configured for receiving uplink signals from the ONUs and for circulating the uplink signals to said one port for uplink transmission from the remote node.

The circulator may comprise a non-full circulator, and an optical fiber may be coupled between adjacent blocked ports disposed between said another and said one port.

The said another port may be configured for transmission of the down link signals and the seeding signal from the EDF.

The light source may comprise an erbium doped, fiber (EDF) coupled between first and second couplers.

The first coupler may comprise a WDM coupler configured for receiving an optical signal comprising a pump signal for the EDF and downlink signals and for transmitting the pump signal to the EDF and for transmitting the downlink signals to the second coupler for combining with the seeding signal for transmission to the ONUs.

The laser source may comprise a Fabry-Perot laser diode (FPLD).

The laser source may comprise a reflective semiconductor optical amplifier (RSOA).

The WDM PON may further comprise a central office comprising a pump source for the light source of the remote node.

According to a second aspect of the present invention there is provided a method of externally seeding an uplink light source in an optical network unit of a wavelength-division-multiplexed passive optical network (WDM PON), the method comprising generating a seeding signal at a remote node of the WDM PON.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating an architecture for the upstream wavelength division multiplexed-passive optical network (WDM-PON) transmission using spectrum sliced ASE source for injection locking of FPLDs, according to the prior art.

FIG. 2 shows a schematic diagram illustrating an architecture of a Raman amplification-based wavelength division multiplexed-passive optical network (WDM-PON) using spectrum sliced ASE source based on recycling of residual Raman pump, according to the prior art.

FIG. 3 shows a schematic diagram illustrating an architecture of a Raman amplified wavelength division multiplexed-passive optical network (WDM-PON) based on Fabry-Perot laser diodes (FPLDs) or reflective semiconductor optical amplifiers (RSOAs) externally seeded by a spectrum sliced ASE source generated at the remote node, according to an embodiment of the present invention.

FIG. 4 shows a schematic diagram illustrating an architecture of a remote node comprising a six-port non-full circulator for a wavelength division multiplexed-passive optical network (WDM-PON), according to an embodiment of the present invention.

FIG. 5 shows a schematic diagram illustrating an architecture of a wavelength division multiplexed-passive optical network (WDM-PON) comprising a remote node with a WDM coupler and a splitter, according to an embodiment of the present invention.

FIGS. 6(a) and 6(b) show the profiles for the variations in the optical power of the Raman pump and the signal along a feeder fiber under high pump power for a first order Raman amplification and a dual order Raman amplification, respectively, according to an embodiment of the present invention

### DETAILED DESCRIPTION

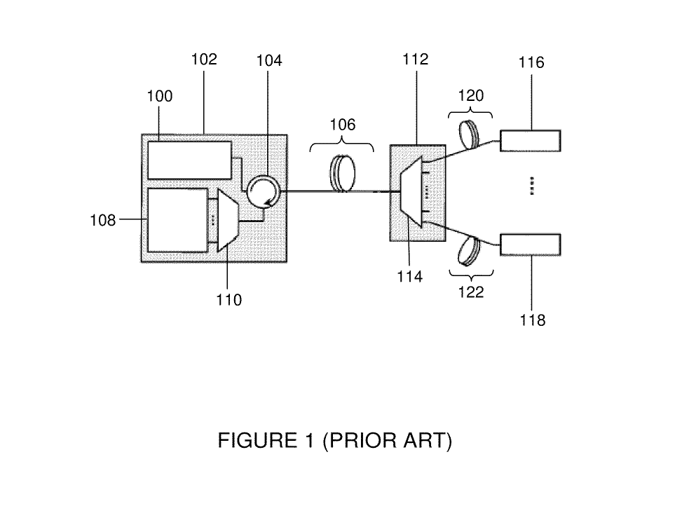

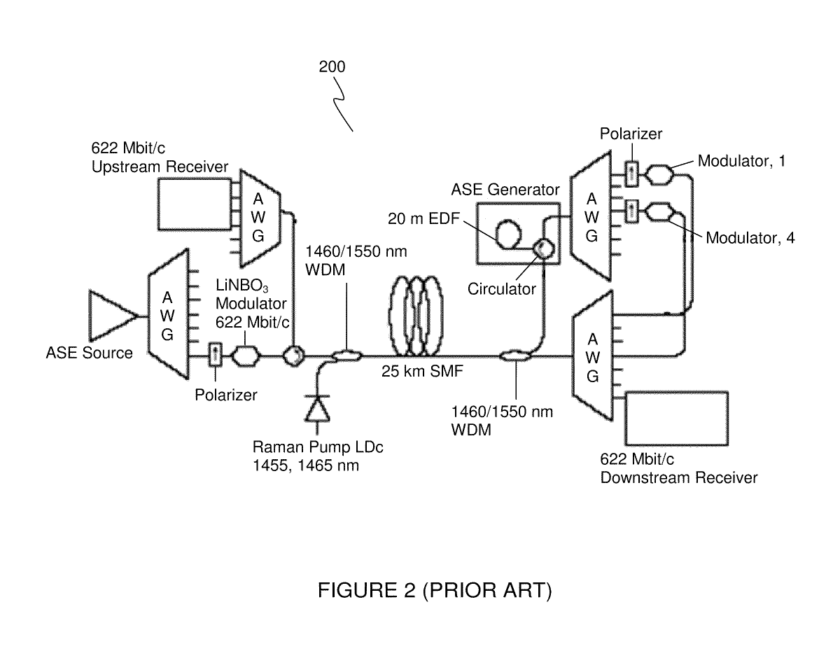

In the present invention, example embodiments have been developed to address the challenges faced by the network architectures of the prior art of FIGS. 1 and 2. Example embodiments of the present invention generally relate to the transmission of the wavelength division multiplexed-passive optical network (WDM-PON), where the spectrum sliced amplified spontaneous emission (ASE) noise is sent to the optical network units (ONUs) to improve the quality of the colorless uplink light sources such as the Fabry Perot laser diodes (FPLDs) or the reflective semiconductor optical amplifiers (RSOAs) via external injection. The ASE noise is generated at the remote node (RN) via an erbium doped fiber (EDF), with the pump for the EDF located at the central office (CO). Example embodiments of the present invention further provide Raman amplification for the uplink and/or the downlink signals.

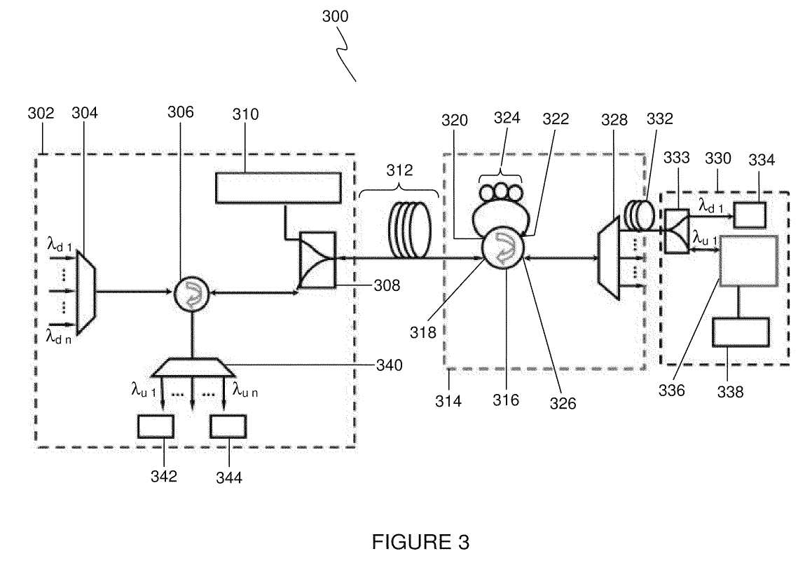

FIG. 3 shows a schematic diagram illustrating an architecture 300 of a Raman amplified wavelength division multiplexed-passive optical network (WDM-PON) based on the Fabry-Perot laser diodes (FPLDs) or the reflective semiconductor optical amplifiers (RSOAs) externally seeded by spectrum sliced ASE source generated at the remote node. It should be appreciated that there are a number of individual optical network units (ONUs) present within the architecture 300 but only a single representative ONU 330 is shown for clarity and illustration purposes. The configurations of the remaining ONUs are similar to that of the representative ONU 330 as shown in FIG. 3 and the descriptions of the operation and function of the ONU 330 hereinafter apply similarly to the other remaining ONUs.

In the embodiment of FIG. 3, in the central office (CO) 302, the downlink signals (λ_{d 1}, . . . , λ_{d n}) at the L band, defined as the wavelength range of 1565-1625 nm, are multiplexed together by the multiplexer (MUX) 304 and transmitted to the WDM coupler/filter 308 via the circulator 306. At the WDM coupler/filter 308, the L band downlink signals (λ_{d 1}, . . . , λ_{d n}) are combined with the pump output light of the Raman pump 310 and transmitted over the feeder fiber 312. In example embodiments, the Raman pump 310 provides Raman gain to the uplink and/or the downlink signals within the WDM-PON.

At the remote node (RN) 314, the downlink signals (λ_{d 1}, . . . , λ_{d n}) and residual pumping light are inputted into a four-port full circulator 316 via port one 318. Port two 320 and port three 322 of the circulator 316 are connected to the erbium doped fiber (EDF) 324, which is used for the generation of the amplified spontaneous emission (ASE) noise spectrum. Accordingly, the combined L band downlink signals (λ_{d 1}, . . . , λ_{d n}) and the residual pumping light from the Raman pump 310 are transmitted into the circulator 316 via port one 318, and are then passed into the EDF 324 via port two 320 and out from the EDF 324 into the circulator 316, via port three 322. The length and ion doping of the EDF 324 can be tailored to allow the generated ASE spectrum to be located within the C band, defined as the wavelength range of 1530-1565 nm.

The output of the circulator 316, comprising the downlink signals and the ASE spectrum, is then transmitted via port four 326 into the cyclic arrayed waveguide grating (AWG) 328 for the demultiplexing of the downlink signals and slicing of the ASE spectrum for external seeding purposes. The output from each of the ports of the AWG 328 is sent to an individual optical network unit (ONU), e.g. 330 via a drop fiber, e.g. 332. At the ONU 330, the coarse WDM filter 333 is used to separate the L band downlink signal and the C band ASE source. The separated downlink signal is detected by the downlink receiver 334, while the separated ASE source is used for seeding the uplink transmitter such as the FPLD or the RSOA 336.

In the uplink transmission, the FPLD/RSOA 336 is directly modulated by the data 338. The uplink signal (λ_{u 1}) at the ONU 330 is transmitted from the FPLD/RSOA 336, via the WDM filter 333 and the drop fiber 332, to the remote node (RN) 314. In example embodiments, the uplink signals are located at the C band. At the RN 314, the uplink signal (λ_{u 1}) is combined with other signals from other uplink channels via the AWG 328. The multiplexed signals from the uplink channels are sent through port four 326 and port one 318 of the circulator 316 and the feeder fiber 312 to the central office (CO) 302. At the CO 302, the uplink signals (λ_{u 1}, . . . , λ_{u n}) pass through the circulator 306 and are then demultiplexed by the demultiplexer (DEMUX) 340 and detected by individual uplink receivers, e.g. 342, 344.

It should be appreciated that the number of downlink and uplink signals, the number of ONUs, the waveband of the downlink and uplink signals, the data rate of the data input 338, the configuration of the circulator 316 and the wavelength of the Raman pump 310 may vary depending on the required architecture in the implementation of the WDM-PON, compared to the example embodiments described herein, without departing from the spirit or scope of the invention.

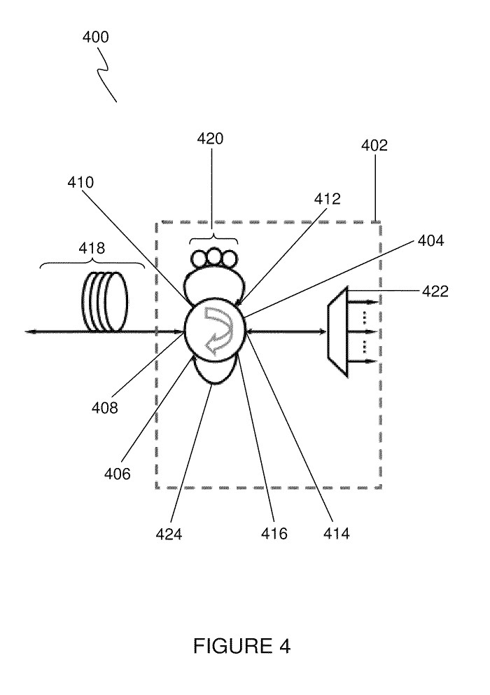

FIG. 4 shows a schematic diagram illustrating an architecture 400 of a remote node 402 comprising a six-port non-full circulator 404 for a wavelength division multiplexed-passive optical network (WDM-PON), according to an embodiment of the present invention. The non-full circulator 404 with 6 ports 406, 408, 410, 412, 414, 416 is used at the RN 402 within the architecture 400 of FIG. 4 as an alternative to the four-port full circulator 316 at the RN 314 of FIG. 3. In the embodiment of FIG. 4, port two 408 serves as the input to the circulator 404 for the downlink signals and the pump output light of the Raman pump (not shown) that are transmitted from the central office (not shown) via the feeder fibre 418. The downlink signals and the residual pumping light then pass through the erbium doped fiber (EDF) 420, connected between port three 410 and port four 412, for the generation of the amplified spontaneous emission (ASE) noise spectrum. The output of the circulator 404, comprising the downlink signals and the ASE spectrum, is then transmitted via port five 414 to the arrayed waveguide grating (AWG) 422.

In the reverse uplink direction for transmissions from the optical network units (not shown) to the central office (not shown), the uplink signals pass through port five 414, the fiber 424 connected between the blocked ports, namely port six 416 and port one 406 and exits the circulator 404 via port two 408 into the feeder fibre 418. The fiber 424 is used as there is no direct route available for the signals to pass from the blocked port six 416 to the blocked port one 406 of the non-full circulator 404.

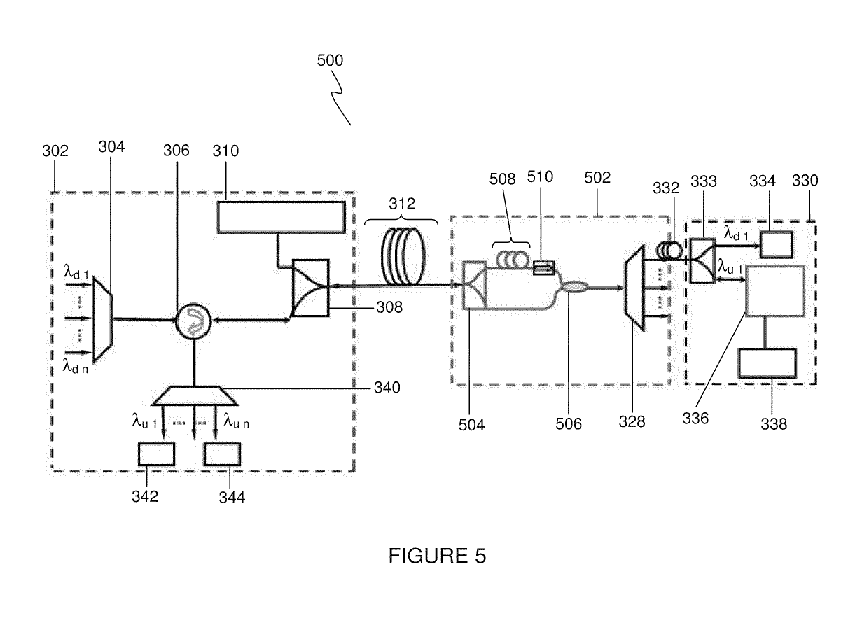

In the example embodiments of FIGS. 3 and 4, the downlink signals and the residual pump light are inputted into the EDF 324 (FIG. 3), 420 (FIG. 4) together. The length of the EDF can be tailored to allow the generated ASE noise to be located within the C band. Alternatively, the residual pump light may be separated from the downlink signals. FIG. 5 shows a schematic diagram illustrating an architecture 500 of a wavelength division multiplexed-passive optical network (WDM-PON) comprising a remote node 502 with a WDM coupler/filter 504 and a coupler/splitter 506, according to an embodiment of the present invention. It should be appreciated that there are a number of individual optical network units (ONUs) present within the architecture 500 but only a single representative ONU 330 is shown for clarity and illustration purposes. The configurations of the remaining ONUs are similar to that of the representative ONU 330 as shown in FIG. 5 and the descriptions of the operation and function of the ONU 330 hereinafter apply similarly to the other remaining ONUs.

The architecture 500 of FIG. 5 is substantially similar to the architecture 300 of FIG. 3, with the exception of the configuration of the remote node 502. Features or modules as illustrated in FIG. 5 that are similarly present in FIG. 3 are denoted by the same reference numbers as that for FIG. 3. As the like modules present in both the architectures 300 (FIG. 3) and 500 (FIG. 5) perform essentially the same functions as that previously described for the architecture 300, the descriptions of the functions and operations of the like modules in the architecture 500 will not be presented here.

In the example embodiment of FIG. 5, the residual pump light is separated from the downlink signals by the WDM coupler 504 at the remote node (RN) 502. The separated residual pump light is then inputted into the EDF 508 for the generation of the amplified spontaneous emission (ASE) source while the downlink signals are transmitted directly to the coupler/splitter 506. The generated ASE source is then transmitted via the isolator 510 to the coupler/splitter 506 where the ASE source is recombined with the downlink signals.

In the architecture 500 of the embodiment of FIG. 5, the downlink signals and the uplink signals may be located at any different wavebands and not necessarily at the L band and the C band, respectively.

In example embodiments of the present invention, as shown in FIGS. 3-5, it should be appreciated that different wavelengths for the pump output at the central office (CO) can be used. In order to achieve a relatively high pumping efficiency for EDF amplification, a pump wavelength of approximately 1480 nm is preferred, in order to provide Raman gain at the L band. A pump wavelength of approximately 1450 nm is preferred in order to provide Raman gain at the C band whilst still maintaining a relatively sufficient pumping efficiency for EDF amplification. Multiple Raman pump lights with various power levels and wavelengths can also be used to provide flat Raman gain for the C band and/or the L band.

In example embodiments of the present invention, for circumstances of uplink transmissions with relatively high data rate using ASE injection locked FPLDs as the ONU light sources, the FPLDs are preferably biased with a relatively high current in order to obtain sufficient modulation bandwidth. However, this may lead to more cavity modes being oscillated, thereby relatively higher injected ASE power may be used in order to suppress other side modes and to achieve single mode operation. Therefore, relatively more residual pump power at the remote node and consequently relatively higher pump power at the central office may be used in order to generate relatively higher ASE power for a given feeder fiber length.

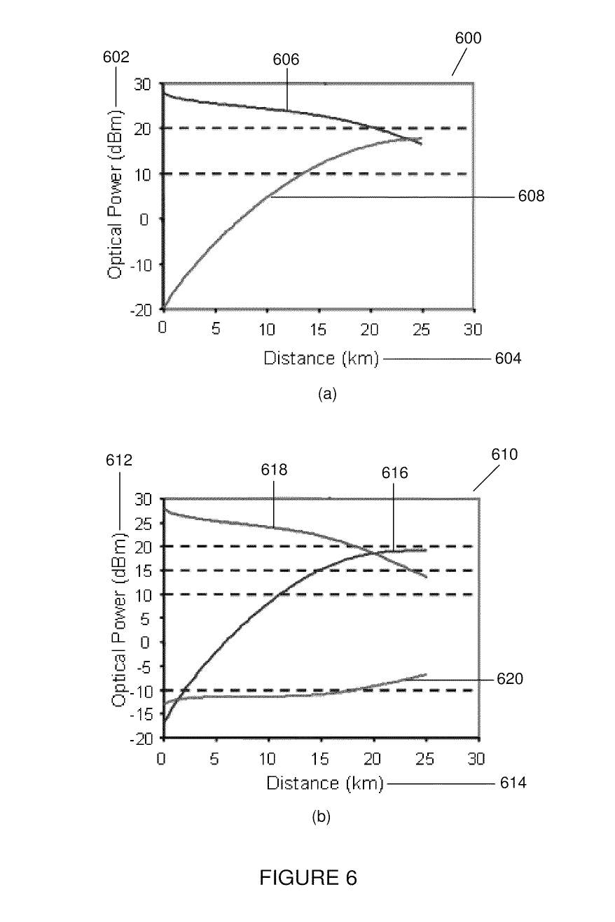

FIG. 6(a) shows the profile 600 of the variations in the optical power 602 of the Raman pump 606 and the signal 608 along the length 604 of a feeder fiber under high pump power situation for a first order Raman amplification, according to an embodiment of the present invention. As shown in FIG. 6(a), when the pump power 606 reaches the Raman threshold, the uplink and/or the downlink signals 608 consume a relatively significant portion of the pump power 606. This may lead to a significantly reduced residual pump power for ASE generation.

As a relatively high Raman gain for the uplink and/or the downlink signals may not be required, alternatively, a dual order Raman pump, for example, with a wavelength of approximately 1390 nm may be used. FIG. 6(b) shows the profile 610 of the variations in the optical power 612 of the first order Raman pump 616, the dual order Raman pump 618 and the signal 620 along the length 614 of a feeder fiber under high pump power situation for a dual order Raman amplification, according to an embodiment of the present invention. As shown in FIG. 6(b), the dual order Raman pump 618 transfers a relatively significant portion of the power to the light (first order pump 616) having a wavelength at approximately 1480 nm, which is used for pumping the EDF for the generation of the ASE spectrum. The uplink and/or the downlink signals 320 also experience Raman gain.

In wavelength division multiplexed-passive optical networks (WDM-PONs), the cost of the light source, specifically the cost of the ONU source, requires particular consideration for the practical implementation of the WDM-PONs. A number of light sources have been considered, as described in the Background section, including externally seeded Fabry-Perot laser diodes (FPLDs) or reflective semiconductor optical amplifiers (RSOAs) by spectrum sliced ASE noise, and directly modulated spectrum sliced ASE source based on the recycling of the residual Raman pump power. Example embodiments of the present invention utilise the externally-seeded FPLDs or RSOAs within the architectures of the WDM-PONs to provide advantageous effects.

Example embodiments of the present invention are applicable to broadband optical access networks, and particularly suitable to wavelength division multiplexed passive optical networks (WDM-PONs). One of the advantages is the extended reach distance for signal transmissions, due to the improved signal power budget offered by the architectures according to example embodiments of the present invention. This is because the amplified spontaneous emission (ASE) spectrum is generated at the remote node and transmitted over a relatively shorter distance over a fiber to the optical network units, thereby minimising loss in the ASE spectrum. In addition, the example embodiments offer the advantageous effects of eliminating the backward Rayleigh scattering of the seeding light in the fiber which may otherwise mix with the uplink signals, thereby minimising the occurrence of crosstalk.

A further advantage is that the example embodiments of the present invention can offer cost-effective architectures for the practical implementation of the wavelength division multiplexed-passive optical networks (WDM-PONs). In particular, the example embodiments of the present invention can use only one arrayed waveguide grating (AWG) at the remote node and one drop fiber for each optical network unit (ONU), compared to the prior art which requires a relatively higher number of components.

Furthermore, the example embodiments of the present invention can be operated at an increased data rate as the sliced ASE source is used for externally seeding the Fabry-Perot laser diodes (FPLDs) or the reflective semiconductor optical amplifiers (RSOAs), rather than using only the ASE signals directly modulated by the uplink data.

It will be appreciated that example embodiments of the present invention can thus provide a number of advantages. These advantages include wavelength division multiplexed-passive optical network (WDM-PON) architectures that exploit Fabry-Perot laser diodes (FPLDs) or reflective semiconductor optical amplifiers (RSOAs) as the colorless light sources at the optical network units (ONUs). The FPLDs or RSOAs are externally seeded by a spectrum sliced amplified spontaneous emission (ASE) source which is generated at the remote node (RN) via an erbium doped fiber (EDF) pumped by a pump light located at the central office (CO).

The use of externally seeded FPLDs or RSOAs as the light sources in example embodiments of the present invention can offer an improved light source quality and an increased uplink data rate. Furthermore, the ASE source is generated at the RN via the EDF, thereby eliminating the backward Rayleigh scattering in the feeder fiber. In addition, as well as providing the pump light for the EDF, the pump light located at the CO can further provide Raman amplification for the uplink and/or the downlink signals.

The example embodiments of the present invention further allow for dual order Raman amplification to be used within the network architectures, particularly when high ASE power is desired for seeding the FPLDs or RSOAs. In this situation, the second order Raman pump advantageously transfers power to the first order Raman amplified light to be used as pump for the EDF for the generation of the ASE noise at the remote node.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

What is claimed is:

1. A wavelength-division-multiplexed passive optical network (WDM PON) comprising:
a remote node (RN) comprising a light source for generating a seeding signal; and
one or more optical network units (ONUs), each ONU comprising a laser source configured for receiving a portion of the seeding light signal from the RN.

2. The WDM PON as claimed in claim 1, wherein the light source comprises a circulator and an erbium doped fiber (EDF) coupled between two adjacent ports of the circulator.

3. The WDM PON as claimed in claim 2, wherein one port of the circulator is configured for receiving an optical signal comprising a pump signal for the EDF and downlink signals and for circulating the received optical signal to the EDF.

4. The WDM PON as claimed in claim 3, wherein another port of the circulator is configured for receiving uplink signals from the ONUs and for circulating the uplink signals to said one port for uplink transmission from the remote node.

5. The WDM PON as claimed in claim 4, wherein the circulator comprises a non-full circulator, and an optical fiber is coupled between adjacent blocked ports disposed between said another and said one port.

6. The WDM PON as claimed in claim 4, wherein said another port is configured for transmission of the down link signals and the seeding signal from the EDF.

7. The WDM PON as claimed in claim 1, wherein the light source comprises an erbium doped fiber (EDF) coupled between first and second couplers.

8. The WDM PON as claimed in claim 7, wherein the first coupler comprises a WDM coupler configured for receiving an optical signal comprising a pump signal for the EDF and downlink signals and for transmitting the pump signal to the EDF and for transmitting the downlink signals to the second coupler for combining with the seeding signal for transmission to the ONUs.

9. The WDM PON as claimed in claim 1, wherein the laser source comprises a Fabry-Perot laser diode (FPLD).

10. The WDM PON as claimed in claim 1, wherein the laser source comprises a reflective semiconductor optical amplifier (RSOA).

11. The WDM PON as claimed in claim 1, further comprising a central office comprising a pump source for the light source of the remote node.

12. A method of externally seeding an uplink light source in an optical network unit of a wavelength-division-multiplexed passive optical network (WDM PON), the method comprising generating a seeding signal at a remote node of the WDM PON.
